(19) United States
(12) Patent Application Publication
(10) Pub. No.: US 2009/0189031 A1
(43) Pub. Date: Jul. 30, 2009

(54) NON-MAGNETIC IV POLE

(76) Inventor: Hillel Skoff, Brookline, MA (US)

Correspondence Address: WOLF GREENFIELD & SACKS, P.C., 600 ATLANTIC AVENUE, BOSTON, MA, 02210-2206, US

(21) Appl. No.: 12/421,938

(22) Filed: Apr. 10, 2009

Related U.S. Application Data
(62) Division of application No. 11/455,606, filed on Jun. 19, 2006.

(51) Int. Cl. F16M 11/00; B21D 47/01

(52) U.S. Cl. 248/176.1; 29/897.33

(57) ABSTRACT

An IV pole is made from a substantially non-magnetic material to enable it to be used in the setting of an IV scanner.

### RELATED APPLICATIONS

This application is a Divisional of U.S. application Ser. No. 11/455,606, filed on Jun. 19, 2006, the subject matter of which is being incorporated herein by reference.

### BACKGROUND OF THE INVENTION

The present invention is directed to an intravenous (IV) pole and, more particularly, to a non-magnetic IV pole that is usable in connection with magnetic resonance imaging (MRI).

### BRIEF SUMMARY OF THE INVENTION

IV poles are widely used, such as in hospital settings, for holding IV bags. IV bags contain fluids and are connected intravenously through IV lines to a patient, enabling the gravity feed of such fluids, and delivery of medicines intravenously through such lines to the patient.

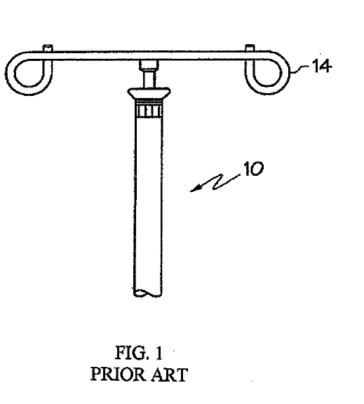

Multiple different IV poles exist in the art. Most include a pole, at the top of which is located a hanging or holding element from which an IV bag is hung or held. A known IV pole is shown for example in FIG. 1, taken from U.S. Pat. No. 6,431,505. As shown, the IV pole includes a pole portion 10 and a hanging portion 14 from which an IV bag is hung.

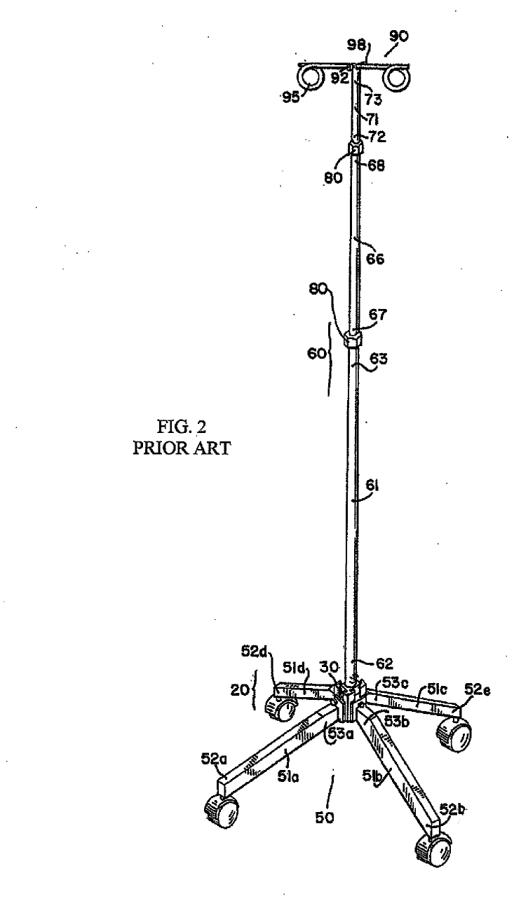

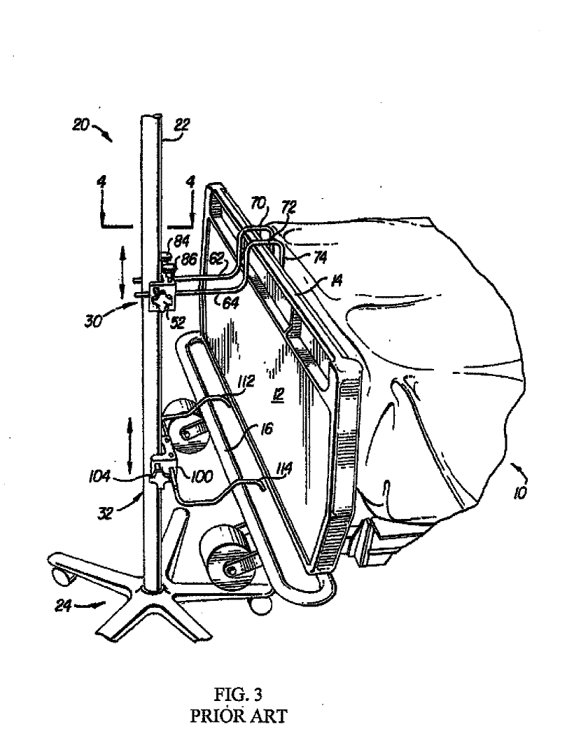

Another known IV pole is shown in FIG. 2, taken from U.S. Pat. No. 5,438,305. Such an IV pole includes a four-legged stand having wheels so that the pole can be moved along the floor with the patient as the patient moves, such as by walking. Another known IV pole is shown in FIG. 3, taken from U.S. Pat. No. 6,079,678. Such an IV pole includes a bracket, enabling it to be removably attached to the foot or head of a patient's bed.

Prior art IV poles are made from metal, such as stainless steel, and are magnetic. Magnetic resonance imaging (MRI) is a radiographic technique that involves scanning a body portion of a patient of interest and enables the reproduction of an image representing the inner anatomy of the portion of the patient scanned. MRI has revolutionized radiology in the past two decades as it provides for viewing portions of a patient's inner anatomy previously unrealizable. It was introduced clinically in approximately 1991 for the scanning of bone and non-bone anatomy. It enables diagnostic imaging of internal organs and bones with precision and high resolution, but without the use of radiation, with which morbidity is associated.

A typical MRI scanner includes a large magnet formed with two poles. A typical scanner also includes a movable surface on which a patient is placed for moving the patient between the poles during a scanning procedure. A high magnetic field is used between the poles to scan the patient.

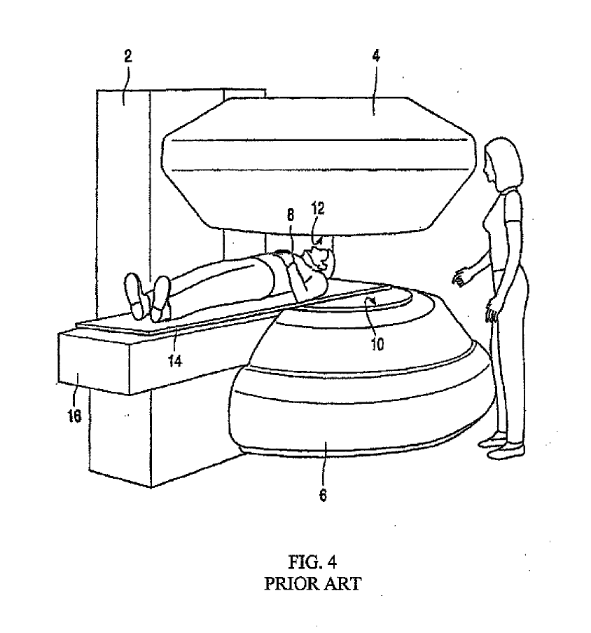

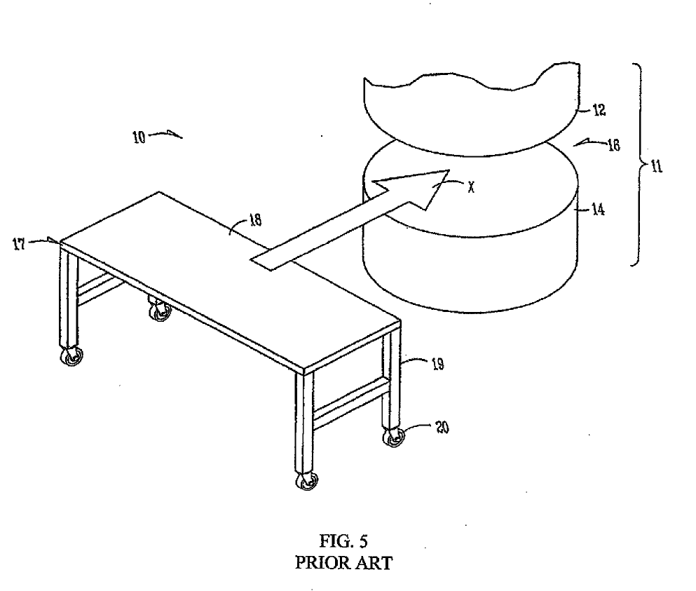

Numerous approaches toward MRI scanning are known in the art. One such approach is illustrated in FIG. 4, taken from U.S. Pat. No. 6,954,069. Shown in FIG. 4 is an MRI machine including a stand 2 carrying a lower magnetic pole 6 and an upper magnetic pole 4. The poles are spaced from one another to allow a patient 8 to be placed between them on a moving table 14. During examination, the patient is moved into a precise position both vertically and horizontally between the poles in order that magnetic radiation will be sent precisely to the location of the patient's body under examination. Another more basic approach is illustrated in FIG. 5, taken from U.S. Pat. No. 6,994,492 in which a movable table 18, on which a patient is placed in a lying position, can be moved to precisely locate the patient between magnetic poles 12 and 14 prior to and during MRI examination.

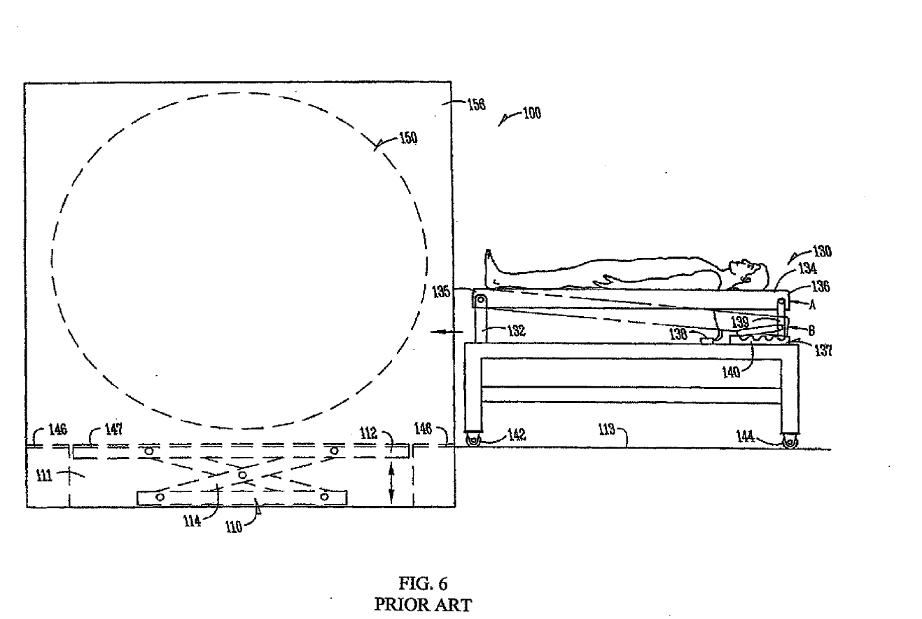

An even further approach is illustrated in FIG. 6, taken from U.S. Pat. No. 6,934,574 in which a patient is placed on a table which is movable vertically and horizontally to precisely locate the body portion of the patient under consideration between magnetic poles of the MRI system prior to and/or during examination.

Because a high magnetic field is utilized during an MRI scan, it is a modality which is contraindicated in patients in whom a ferric metal has been implanted for various ancillary medical reasons, such a pacemaker for arrhythmia, vascular clips for an aneurysm and metallic fixation devices for bony surgery.

Patients in a hospital and who are receiving IV fluids or medication, who would benefit from MRI, require the removal of the IV pole before undergoing an MRI scan. This is so because the IV pole is metal and therefore magnetic. The powerful magnet used in an MRI attracts metallic magnetic devices, such as IV poles, to such a degree as it would constitute a significant danger to the patient. Removing IV lines and bags from an IV pole, in order to scan a patient using MRI, can be difficult and time consuming.

Additionally, some patients, such as those critically ill and/or under intensive care, require ongoing intravenous medication and/or fluids making MRI examination enormously difficult or risky.

### SUMMARY

Applicant herein has recognized the extreme value MRI imaging has in terms of diagnosing patients, particularly in patients who are quite ill, involved in critical care, and are in hospital stay. Applicant herein also has recognized the significant limitation the use of IV poles places on the ability to scan such patients with MRI.

As a result, Applicant herein has invented an IV pole made from a non-magnetic material. Such an IV pole can be of any known physical arrangement or design. The material from which to manufacture the IV pole can be a fiber and/or graphite-based material, including, but not limited to, a composite material, so long as that material is non-magnetic or has a sufficiently low magnetic component so as to enable it to be used safely in the setting of an MRI scanner. Such materials also must be of sufficient strength to enable it to support IV bags and be used durably in hospital settings.

### DETAILED DESCRIPTION OF THE INVENTION

FIGS. 1, 2 and 3 illustrate various arrangements of IV poles. As described, IV poles hold IV bags from which IV fluids and medicines are delivered intravenously through lines to patients. IV poles are known to be extendable, movable on wheels and/or attach to beds, and have various designs, arrangements, and attachments. Prior IV poles have been made from magnetic metals and are not usable safely in the setting of an MRI scanner.

FIGS. 4, 5 and 6 illustrate various arrangements of known MRI scanners. As described, MRI scanners utilize magnetic poles that form a magnet which emit a strong magnetic field during MRI imaging. While MRI has the advantage of not emitting X-ray radiation, with which morbidity is associated, particularly when delivered in high doses, and which has the benefit of enabling visualization of internal patient anatomy with a high degree of resolution, it cannot be used safely in the setting of large magnetic, metallic devices such as IV poles.

An embodiment of the invention is directed to an IV pole made from a non-magnetic material. The material must be strong enough to act as an IV pole and support IV fluid bags, but must be non-magnetic or have only a limited amount of magnetism so as to be used safely in the setting of an MRI scanner. The materials from which such an IV pole may be made include any now-known or later developed non-magnetic materials such as, but not limited to, titanium, fiber, and/or graphite-based composite materials, or any combination of these and other materials. Composite materials are known in the sporting goods industry and in the explosives industry. It is shown to be of sufficient weight, durability and reasonably priced when compared to titanium.

What is claimed is:

1. A method comprising:
making a pole, that is capable of holding an IV bag for human medical use, substantially from graphite such that the pole is substantially non-magnetic, enabling the pole to be used safely in the vicinity of an MRI scanner.

2. A method as claimed in claim 1, wherein the step of making includes making the pole from a graphite-based composite material.

3. A method comprising:
using an IV pole, made substantially from graphite, to hold an IV bag for delivery of liquid to a human medical patient while the patient is undergoing an MRI scan from an MRI scanner.

4. A method comprising:
making a pole substantially from graphite such that the pole is substantially non-magnetic; and
using the pole to hold an IV bag for delivery of liquid to a human medical patient while the patient is undergoing an MRI scan from an MRI scanner.
